(19) United States
(12) Patent Application Publication
(10) Pub. No.: US 2002/0105973 A1
(43) Pub. Date: Aug. 8, 2002

(54) Systems and methods for improved time slot synchronization using enhanced two-times oversampling

(75) Inventors: Shuzo Kato, San Diego, CA (US); Kiyotaka Ogata, San Diego, CA (US)

Correspondence Address: LYON & LYON LLP, 633 WEST FIFTH STREET, SUITE 4700, LOS ANGELES, CA, 90071, US

(73) Assignee: MITSUBISHI WIRELESS COMMUNICATIONS, INC

(21) Appl. No.: 09/775,695

(22) Filed: Feb. 2, 2001

(51) Int. Cl. H04J 3/06; H04B 7/212

(52) U.S. Cl. 370/503; 370/237; 370/345

(57) ABSTRACT

A time slot synchronizer that includes a sampler, which is configured to successively sample a baseband signal. The baseband signal is divided into a number of frames, and each frame is divided into a plurality of symbols. The sampler divides each symbol into a plurality of sample bins and generates a first sample group from a first frame by sampling each symbol in the first frame. The sampler uses a predetermined first and second sample bin for sampling the first frame. Next, the sampler generates a second sample group from a second frame by sampling each symbol in the second frame in a third and fourth sample bin. The third and fourth sample bins, however, are shifted a certain number of sample bins relative to the first and second sample bins, respectively.

### BACKGROUND OF THE INVENTION

1. Field of the Invention

The field of the present invention relates generally to wireless communication in TDMA networks, and more specifically to systems and methods for enhanced slot synchronization using two-times oversampling.

2. Background

In wireless communication networks that implement Time Division Multiple Access (TDMA), a mobile station (MS) must first acquire a control channel from a local base station (BS) and synchronize slot timing prior to initiating end-user communication. A MS in a TDMA network is traditionally a handset used for voice communication; however, a MS can be a PDA or other device that includes the appropriate hardware. FIG. 1 is a simplified flow diagram of an MS channel acquisition and synchronization methodology commonly used in TDMA systems. Channel acquisition begins with step 101 when the MS initiates a search for an available digital control channel on which to camp. Very often, this occurs immediately after the MS has been powered on, but channel acquisition is also a necessary component of the hand-off, reselection, or other channel switching scheme. In the widely implemented GSM standard deployed throughout Europe, the MS scans all 124 available RF channels in order to identify the channel whose average signal strength is greatest. Other TDMA networks may implement channel scanning differently; however, each implementation assesses the relative signal strength of the scanned channels and attempts to acquire on the strongest channel. As a result, channel scanning often takes a few seconds. As part of the channel scanning process, the mobile station's receiver adjusts its sensitivity above an appropriate safety margin in order to guard against signal loss caused by channel fading. Sensitivity adjustment is especially important in systems designed with large cell boundaries because the MS must maintain connectivity with a BS at substantial distances.

In step 102, the receiver initiates frequency synchronization. A root cause of synchronization failure is often the frequency offset associated with oscillator mismatch between the transmitter and the receiver. A second cause of frequency offset stems from the effects of Doppler shift. Doppler shift is the natural phenomenon responsible for a measurable and unwanted carrier frequency offset caused by the relative motion between transmitter and receiver inherent in a mobile system. Frequency synchronization suppresses and corrects this undesirable frequency offset. If a receiver is unable to correct for frequency offset (step 103) the mobile station must scan and acquire on another channel.

Time slot synchronization, on the other hand, ensures that the time-sliced message bitstream between the MS and the network can be faithfully decoded. In other words, without MS-BS synchronization, no conversation can take place. Time slot synchronization occurs in Step 104. Successful demodulation of a radio frequency (RF) signal depends upon the receiver's ability to correctly identify the beginning and ending of a symbol. Thus, time slot synchronization works at the physical layer to establish the precise boundaries of a TDMA frame embedded within an RF carrier. If synchronization fails in step 104, the MS must attempt channel acquisition on the channel with the next highest signal strength, and the processes of frequency offset and timing offset adjustment begin anew.

Slot synchronization is accomplished by the use of a synchronization signal portion embedded within the TDMA timeslot. The GSM standard, for instance, embeds a sync word in the middle of a burst. Other TDMA implementations place a sync word with the slot preamble at or near the beginning of the time slot. In any case, the sync word acts as a training sequence to authenticate synchronization and channel acquisition.

Unfortunately, if synchronization between transmitter and receiver fails, the MS is forced to scan the RF hyperband for another candidate channel on which to acquire service. Ultimately, if all attempts at channel synchronization fail, the user is unable to register with, and obtain service from, the network.

Current synchronization methods rely on sampling techniques that frequently and unnecessarily deny channel acquisition. While sampling methods exist which would permit synchronization of the received signal at nearly every attempt, such methods (e.g., 8-times oversampling) suffer considerable real-time disadvantages. Among the drawbacks associated with a high sampling rate are (1) unneeded power consumption (2) excessive drain on battery life, and (3) overuse of receiver MIPS.

### SUMMARY OF THE INVENTION

To combat the problems of current synchronization methods, there is provide a time slot synchronizer for use in a wireless receiver. The time slot synchronizer comprises a sampler, which is configured to successively sample a baseband signal comprising a plurality of frames, wherein each frame comprising a plurality of symbols. The sampler then divides each symbol into a plurality of sample bins and generates a first sample group from a first frame by sampling each symbol in the first frame. The sampler uses a predetermined first and second sample bin for sampling the first frame. Next, the sampler generates a second sample group from a second frame by sampling each symbol in the second frame in a third and fourth sample bin. The third and fourth sample bins, however, are shifted a certain number of sample bins relative to the first and second sample bins, respectively. The time slot synchronizer also includes a correlator configured to correlate the first and second groups of samples with a stored sync word in order to generate a final correlation estimate, and a comparator configured to compare the final correlation estimate to a correlation threshold.

There is also provided a mobile station that includes a receiver for receiving a signal. The mobile station also includes a demodulator coupled to the receiver, wherein the demodulator is configured to take the signal and to generate a baseband signal comprising a plurality of frames, each frame comprising a plurality of symbols, as discussed above. Therefore, the demodulator includes a sampler, a correlator, and a comparator, such as those described in relation to the time slot synchronizer.

There is also provided a method for time slot synchronization using a sampler configured to successively sample a baseband signal comprising a plurality of frames, each frame comprising a plurality of symbols. The method comprising dividing each symbol into a plurality of sample bins, generating a first sample group from a first frame by sampling each symbol in the first frame in a first and second sample bin, and then generating a second sample group from a second frame by sampling each symbol in the second frame in a third and fourth sample bin. As before, the third and fourth sample bins being shifted a certain number of sample bins relative to the first and second sample bins, respectively. The next step is correlating the first and second groups of samples with a stored sync word in order to generate a final correlation estimate, then comparing the correlation estimate to a final correlation threshold.

Other systems and methods of the invention will become apparent from the following Detailed Description of Preferred Embodiments, when considered in conjunction with the accompanying drawings.

### BRIEF DESCRIPTION OF THE DRAWINGS

Preferred embodiments of the inventions taught herein are illustrated by way of example, and not by way of limitation, in the figures of the accompanying drawings, in which similar elements in the different embodiments are referred to by the same reference numbers for ease in illustration, and in which:

FIG. 1 is a flow chart illustrating a process for channel acquisition in a wireless communication network that implements TDMA.

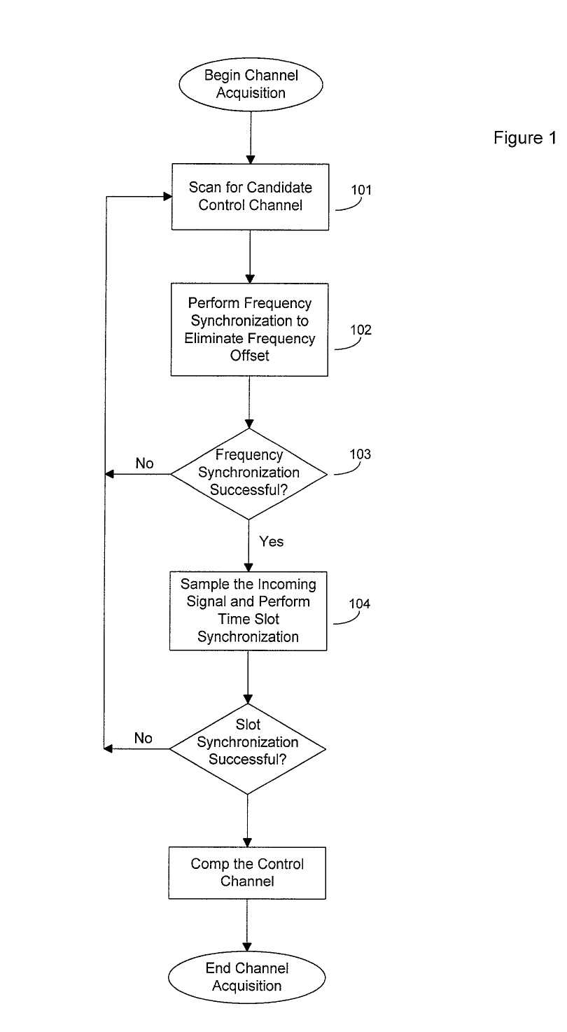

FIG. 2 is a diagram illustrating a TIA -136 frame structure and possible timing scenarios relative to decoding the frame.

FIG. 3 is a diagram illustrating correlation results for the scenarios illustrated in FIG. 3.

FIG. 4 is a diagram illustrating the effects of enhanced two times oversampling on the correlation results of FIG. 3.

FIG. 5 is a diagram illustrating two times oversampling.

FIG. 6 is a diagram illustrating one scenario for enhanced two times oversampling in accordance with the invention.

FIG. 7 is a diagram illustrating a second scenario for enhanced tow times oversampling in accordance with the invention.

### DETAILED DESCRIPTION OF THE PREFERRED EMBODIMENTS

Though the motivation for accurate slot synchronization is clear, real-time slot synchronization, as a practical matter, is inherently difficult to implement. Time slot synchronization methods rely chiefly upon statistical sampling and analysis to pass judgment on whether signal acquisition is achievable. In one embodiment of the improved slot synchronization systems and methods, synchronization relies on an average correlation over multiple frames between (1) a 14-symbol sampled signal sequence, and (2) a known sync word stored in the receiver. If the correlation is above a known, pre-determined threshold value, synchronization will be established and upper-layer messaging may proceed.

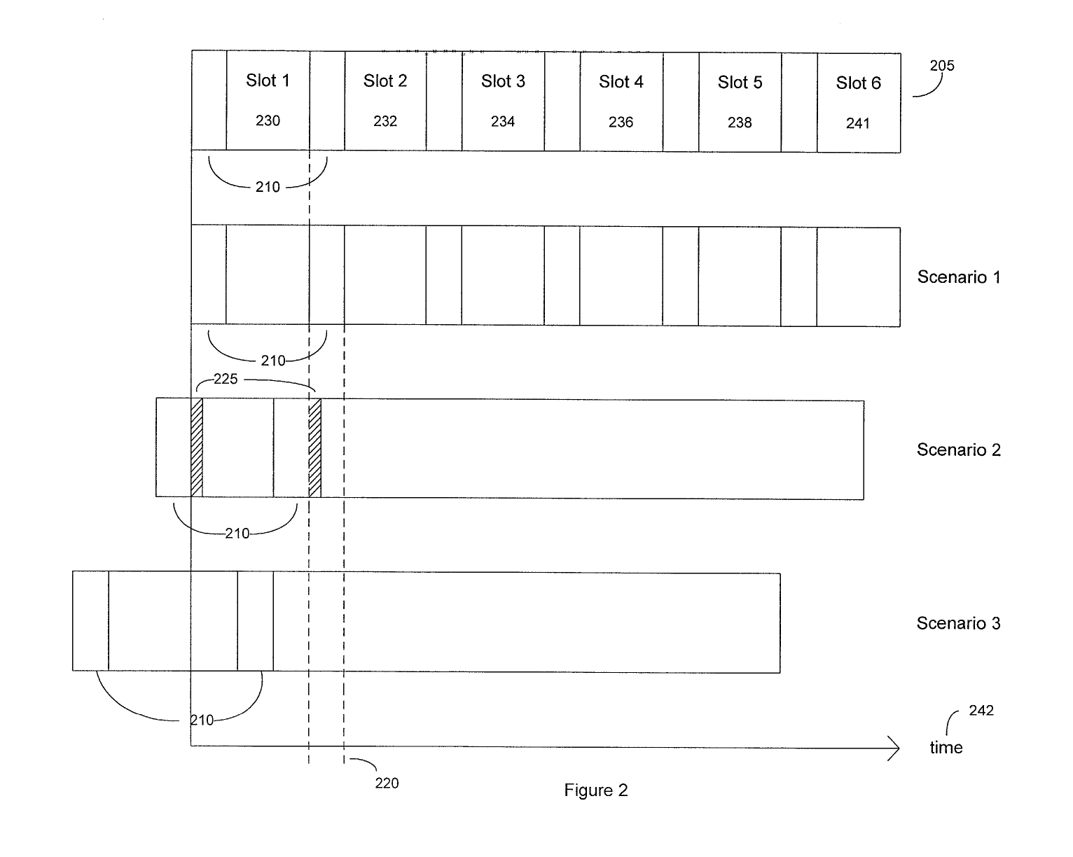

By way of example, FIG. 2 employs the TIA/EIA-136 international standard to illustrate the structure of a frame. The 486-symbol frame 205 is a physical unit of digital signal transmission divided equally into six time slots 230, 232, 234, 236, 238, and 240. Each time slot is typically 20 ms for TDMA networks. Appended to the front of each time slot is a sync word 210, 14 symbols in length. A symbol is the 2-bit fundamental unit of data encoding in a quadrature-keyed system of modulation. For our purposes, the symbol is an appropriate level of abstraction with which to develop the improved slot synchronization systems and methods because signal demodulation at the bit level occurs in the receiver only after synchronization at the symbol level.

FIG. 2 also shows three representative scenarios that are illustrative of the difficulty a receiver faces when attempting to establish slot synchronization. The difficulty is primarily a result of a receiver's inability to begin sampling an incoming carrier signal at precisely the beginning of a sync word 210. All three scenarios are superimposed along a horizontal axis that represents time 242. Time TO represents the point in time where a MS begins to sample the noiseless, filtered incoming baseband analog signal. Wireless receivers included in MSs use sampling methodologies that rely heavily on mathematical correlation to draw synchronization conclusions. Correlation is facilitated by including, as the sync word 210 in every time slot, a known arbitrary bit sequence of predetermined length. The receiver houses a correlator (implemented for example as firmware or hardwired logic) which also stores the known bit sequence (sync word) and makes correlation estimates by combining the sampled data with the stored sync word in a statistical manner. If correlation between a series of samples and a known sync word is strong, i.e., above some pre-determined threshold value, then synchronization is presumed. The pre-determined threshold is often expressed as a ratio or percentage of the fully correlated peak value, or alternatively it may be set as an arbitrary baseline value. A weak correlation, on the other hand, often precludes synchronization altogether, forcing the receiver to acquire and camp on another channel.

Scenario 1 of FIG. 2 illustrates the rare situation where the receiver fortuitously begins sampling the first symbol 244 of the sync word 210. As an entire14-symbol sequence happens in this case to coincide exactly with the full sync word 210, correlation between the 14-symbol sequence and the stored sync word will be 100%.

However, as scenario 2 shows, the frames can be slightly misaligned as a result of timing offset. The horizontal dashed lines 220 from the perfectly correlated scenarios have been extended and superimposed over the scenario 2 sampled frame. The consequence of beginning to sample a TDMA frame midway into a sync word 210 will be a correlation result substantially lower than the correlation result of scenario 1. The hashed region of overlap 225 represents a smaller quantity of time in which sampled data values corresponding to a sync word 210 of a frame can be extracted from the received signal. Such smaller number of sampled data points translates mathematically into a significant decline in the resultant correlation output. Nevertheless, in scenario 2, the receiver may still establish synchronization provided that the correlation output lies above a predetermined threshold level.

Finally, scenario 3 depicts a total lack of synchronization. The first 14 symbols of the sampled frame do not coincide in time with any portion of an actual sync word 210. Thus, correlation here will be close to zero. Some positive correlation is mathematically inevitable, however, meaning the correlation will rarely be exactly zero. Despite this, the below-threshold correlation in scenario 3 is enough to force the receiver to attempt acquisition on a different channel-one where a stronger correlation, and hence a greater chance at establishing synchronization, is possible.

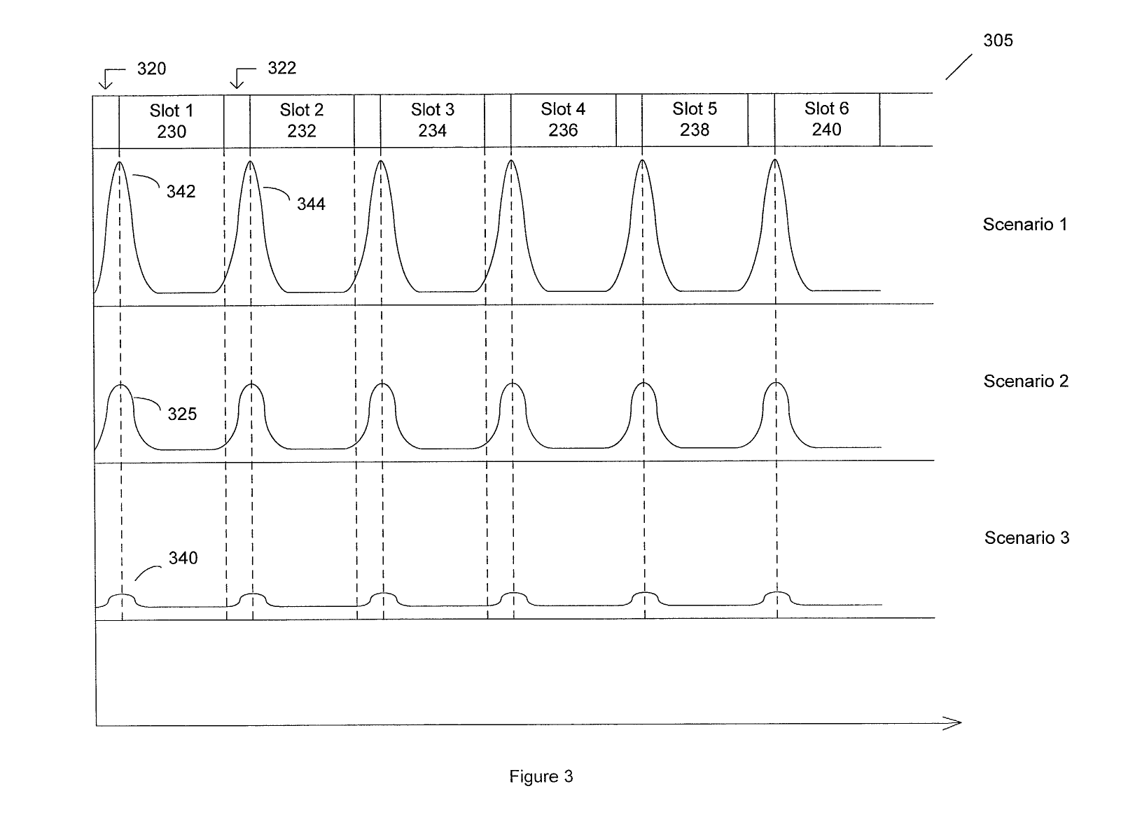

FIG. 3 displays the output correlation that results from each of the three scenarios of FIG. 2. As in FIG. 2, all 3 scenarios are aligned along a horizontal axis of time 310 for purposes of comparison. A perfectly aligned TDMA frame composed of six slots 305 aids in visualizing the timing associated with the forgoing correlation outputs of the 3 scenarios. Time TO again represents the point in time that coincides with the beginning of frame sampling.

For scenario 1, the correlation is maximum because the 14-symbol sampled sequence for time slot 1 (230) correlates perfectly with an entire 14-symbol sync word 320. Thus, the peak of the correlation output 342 is greatest at time T1, namely, the point in time at which 14 symbols have been sampled and correlated. A correlation estimate before this point in time will not be expected to reach a peak value because the correlator will not have received the required 14 sample data points necessary to achieve full correlation with a 14 symbol sync word. Continuing in this manner, correlation output will reach a second peak value 344 only after a full slot has been processed and the correlator begins to receive sample data from the sync word 322 appended to time slot 2 (232). The number of peak correlation data points necessary to deem a sampled signal synchronized is correlator-dependent. Some correlators may make this determination after sampling only a single frame. However, the improved synchronization systems and methods achieves its superior synchronization ability by extending the number of correlation estimates over several frames.

For scenario 2 of FIG. 3, the correlator estimates a much lower correlation result 325 because the region of overlap between sampled input and sync word is minimal. For instance, the receiver may only receive, say, five of the 14 symbols that make up a sync word. In such a case the correlation output will result in effective slot synchronization only if the peak value 325 exceeds the predetermined threshold.

Finally, scenario 3 exemplifies a random, noise-like correlation output with no identifiable peak correlation output estimates 340. The samples taken between time T0 and time T1 contain no data that is strongly correlative with any sync word, resulting in a flat, nearly zero output. While one might expect a zero correlation result for each sample in scenario 3, probabilistic uncertainty inherent in a statistical formulation such as correlation ensures a positive correlation some percentage of time.

FIG. 3 depicts time slot synchronization in an environment with no oversampling. However, correlators frequently accept and process multiple concurrent data samples in effort to improve correlation. Hence, synchronization expectancy is further bolstered through the use of so-called oversampling. That is, oversampling improves the probability that an above-threshold correlation will be found for a given received signal. Because the oversampling level (i.e., 2-times, 4-times, or 8-times oversampling) achieves greater synchronization accuracy at the expense of other design parameters, notably power consumption and MIPS expenditure, the systems and methods for improved synchronization employs two-times oversampling as a compromise in this design trade-off.

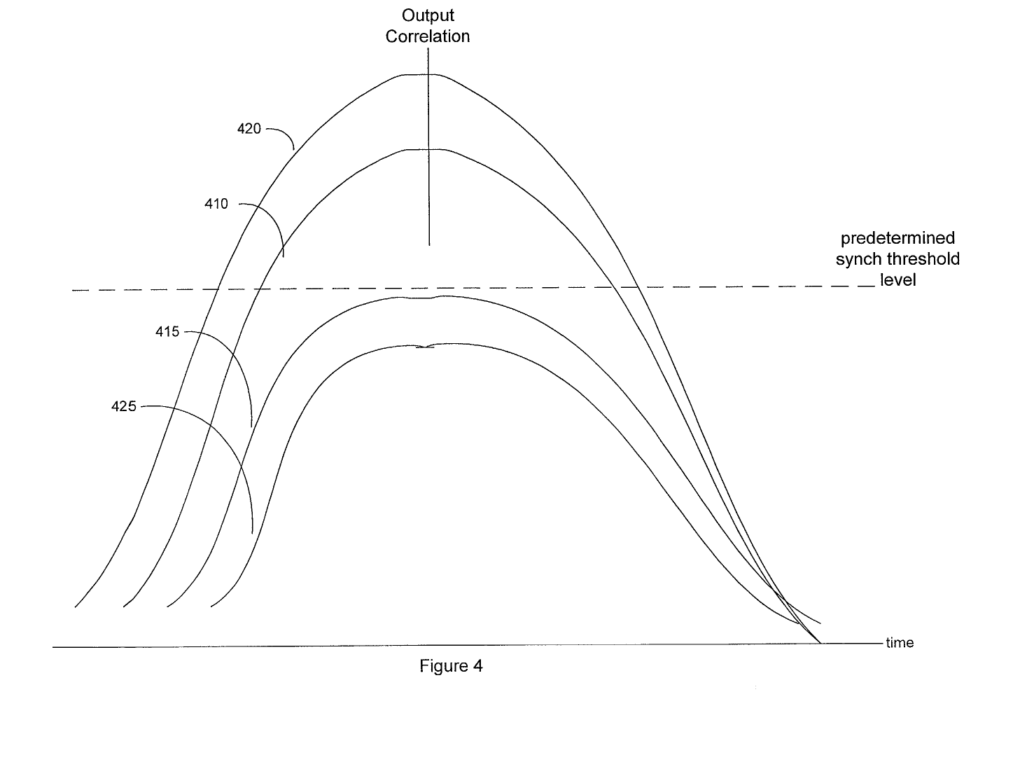

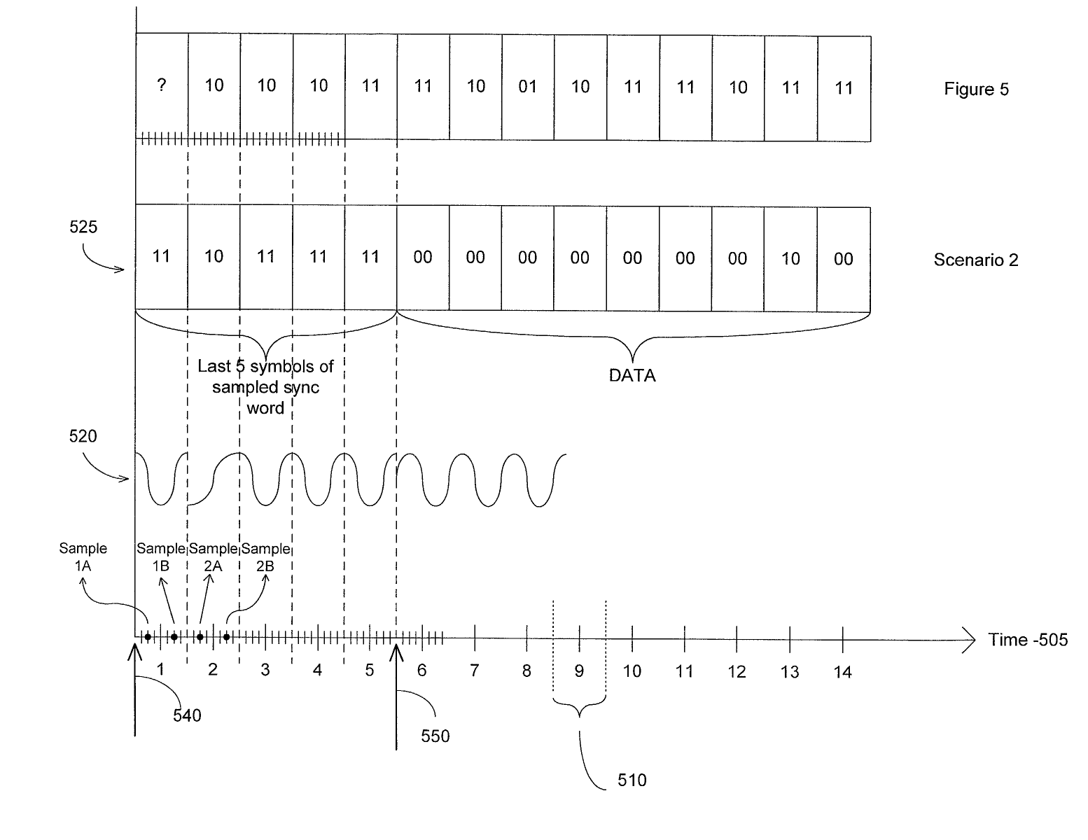

Enhanced two-times oversampling carried out by the systems and methods for improved time slot synchronization divides a symbol period into equal-sized sample “bins.” The number of sample bins may vary among implementations. A bin is nothing more than an arbitrary time unit in which a sample is taken. Furthermore, because the samples are taken at discretely separate moments in time, the sample rate, when considered over a series of consecutive frames, appears as quasi-four-times oversampled, as further described with reference to FIG. 4 and FIG. 5 below.

FIG. 4 illustrates the effects of oversampling on the correlation output using scenario 2 of FIG. 3 as a vehicle for discussion. In the absence of oversampling, the expected output correlation 342 of scenario 2 as amplified in FIG. 4, 425, may not exceed the minimum predetermined threshold level for synchronization. In such a situation, we have seen, channel acquisition will be denied. Even with 2-times oversampling, 415, the result may fall short of the predetermined synchronization threshold. A primary objective of the systems and methods for improved synchronization using enhanced two-times oversampling is attainment of a peak correlation output estimate that surpasses the synchronization threshold, all else being equal. This objective is met by correlation output curve 410 of FIG. 4. Finally, although highly sought, full correlation 420 is both unlikely and unnecessary for achieving synchronization in most signal reception situations.

FIG. 5 illustrates the systems and methods for slot synchronization using enhanced two-times oversampling by showing an enlarged view of a sync word 210 from scenario 2 of FIG. 2. The horizontal axis of FIG. 5 is demarcated in units of time, each time unit equal in length to a symbol period 510. A symbol period is the fundamental unit of sample time and is equivalent to the width of an encoded bit-pair used in the transmitter's modulation scheme. For TDMA systems based on QPSK, a phase modulation baseband signal 520 is used to encode the digital bitstream 525 prior to transmission over the wireless channel. Sampling, accordingly, is that subprocess of slot synchronization by which a receiver extracts symbol information 525 from the baseband signal 520 by making correlation estimates based on phase measurements of the signal.

The first five sample periods beginning with time T0 and ending with time T1 represent the equivalent time period drawn between time T0 and time T1 of FIG. 3 and also the shaded region 225 of FIG. 2. Thus, in FIG. 5, the period T1-T0 is an enlarged view of that portion of the received signal sync word 210 that coincides with the beginning of the sampled frame 540 and ending with the end of the sampled signal sync word 550.

Finally, FIG. 5 sets a framework to begin a discussion of two-times oversampling. With two-times oversampling, the receiver samples the baseband signal at two discrete points in time within a single symbol period. The first sample point 1A comes before the symbol period center point and the second sample point 1B comes after the symbol period center. In order to achieve seamless two-times oversampling from symbol to symbol, we divide a symbol period into eight equally sized bins. Whereas the signal would have been sampled in the center of each symbol period under a scheme without oversampling, each symbol is now sampled twice per symbol period, once at the location in time two bins to the left of symbol period center, and once at the location in time two bins to the right of symbol period center. Thus, two-times oversampling results in two correlation data points per symbol period, further increasing the probability that the correlation output will register above the synchronization threshold level. The actual number and location of bins used for two times over sampling can very depending on the application; however, typical receivers are capable of a maximum of eight bins.

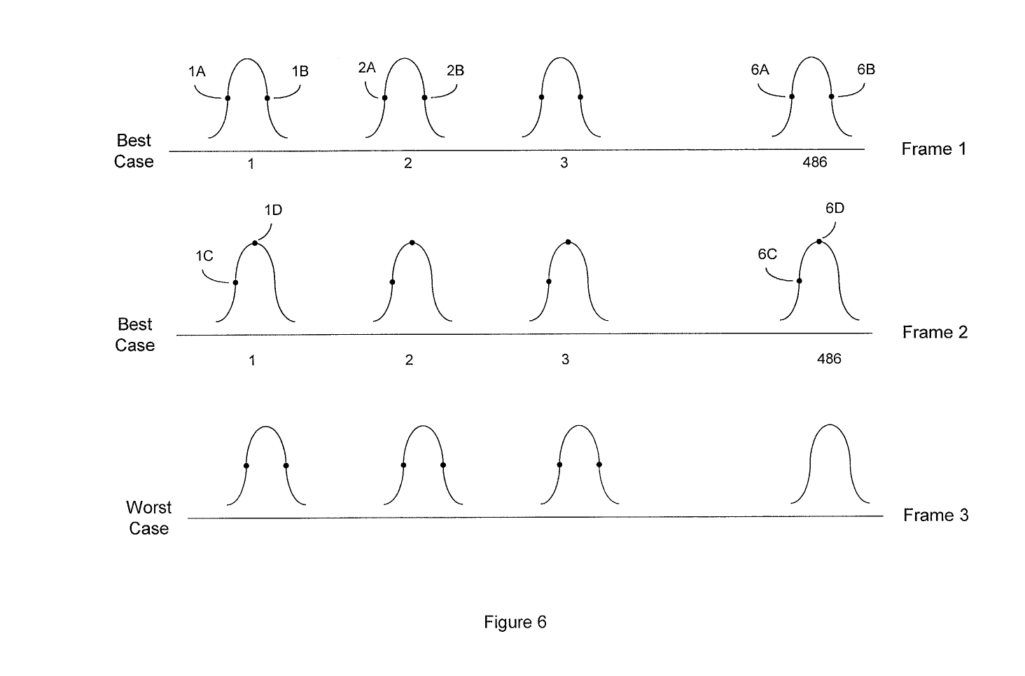

The systems and methods for improved slot synchronization uses enhanced two-times oversampling. Enhanced two-times oversampling differs from standard two-time oversampling described above. In one embodiment, a full 486-symbol frame is sampled and correlated using 2-times oversampling. The sample bins are then shifted 2 sample points to the center and edge of the symbol period before sampling and correlating the next 486-symbol frame, producing the effect shown in FIG. 6 and further described below. It should be noted that not only can the sample bins used for the first samples vary depending on the implementation, but how far and in what direction in time the sample bins are shifted for subsequent samples can also vary depending on the implementation. The goal is to achieve correlation in situations where there is an adequate signal, but where correlation may nonetheless fail due to the inherent limitations in current sampling techniques. Therefore, other embodiments can use different bins and/or different shifting schemes to achieve this goal.

FIG. 6 depicts the frame-by-frame sequence of enhanced two-times oversampling according to one embodiment of the systems and methods for improved slot synchronization. Enhanced two-times oversampling begins sampling the baseband signal at sample points 1A and 1B, 2A and 2B, and so on up to 6A and 6B as described with reference to standard two-times oversampling in FIG. 5. The ‘A’ series samples of FIG. 6 are those samples taken at sample points within each symbol period that occur two bins to the left of symbol period center. Likewise, the ‘B’ series samples are taken at sample points within each symbol period that occur two bins to the right of symbol period center. Correlation estimate 1A is calculated by the correlator based on the ‘A’ series samples, while correlation estimate 1B is calculated by the correlator based on the ‘B’ series samples.

The correlator in one embodiment performs a correlation estimate on the ‘A’ series samples only after receiving and storing 14 ‘A’ series sample values. The result will be a correlation output data point that falls either on or below peak correlation as discussed previously with respect to FIG. 3. With reference to FIG. 6, the first ‘A’ series estimates are plotted (for purposes of illustration) for frame 1 for the incoming signal of scenario 2 first introduced in FIG. 2. The plotting of correlation estimates continues until 6 ‘A’ series and 6 ‘B’ series estimates are complete. FIG. 6 depicts a situation, for purposes of illustration, where the correlation estimates exhibit the worst case setting. In other words, the expected peak correlation was not achieved for any of the 6 estimates. Rather, the correlation estimates each fell short of reaching the predetermined synchronization threshold level for estimates 1A through 6A as well as for 1B through 6B. Where some sampling methodologies would surrender channel acquisition for failure to synchronize, the systems and methods for improved synchronization using enhanced two-times oversampling initiates the series ‘A’ and series ‘B’ sampling scheme all over again on a second frame with one important difference. For the second frame samples, the two sample points of each symbol period are each shifted left by two sample bins. Thus, the ‘C’ series samples produce correlation estimates by sampling a symbol period at a sample point four bins to the left of symbol period center. Likewise, the ‘D’ series samples produce correlation estimates by sampling a symbol period at the symbol period center. The ‘C’ series and ‘D’ series estimates are plotted for frame 2 until six series ‘C’ and six series ‘D’ estimates are complete.

The desired result of shifting sample points by two bins before sampling frame 2 is a higher correlation output for the frame 2 estimates, possibly resulting in discovery of full correlation. The frame 2 series of correlation estimates of FIG. 6 represent the best case situation, where one, if not all six, of the estimates will find the peak correlation. In certain embodiments, the sampling can stop as soon as a correlation above the threshold is obtained. In other embodiments, more frames can be sampled and used in the correlation process. For example, a third frame can be sampled in which case, the sample bins are shifted back to their original position. For a fourth frame, the bins are again shifted by two as with the second frame and so on. The correlation estimates for the various frames are then averaged prior to synchronization determination.

FIG. 6 represents the case where the position of the sample bins for the first frame fall in the worst case position, i.e., peak correlation will never be found by either sample bin. But the enhanced two times oversampling results in one of the sample bin being in the best case position for the second frame, i.e., one of the sample bin positions for the second frame will result in peak correlation. Therefore, a reasonable correlation threshold should result in synchronization when the correlations are combined for frame 1 and frame 2, and frame 3, frame 4, etc., if required. Thus, correlation can be achieved even when the position of the frame 1 sample bins are worst case.

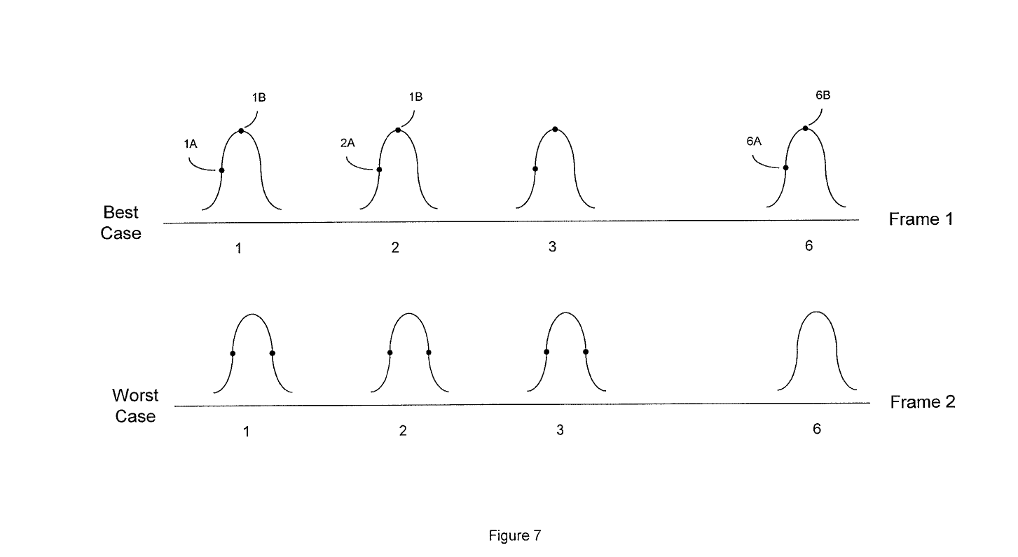

FIG. 7 is a graphical representation of a hypothetical correlation output according to the systems and methods for improved synchronization where the series ‘A’ and series ‘B’ estimates happen to find peak correlation during frame 1 estimation, i.e., at least one of the frame 1 sample bin positions are best case. In certain embodiments, the luck of a high correlation result on the first frame might lead us to conclude that the best case has been found and that no further sampling is required. This assumption is unwise because the high correlation, despite being in excess of the synchronization threshold level, may not be the correlation peak. Advantages accrue from achieving true peak correlation; hence, in other embodiments a second frame, and third and fourth, etc., will also be sampled even when the threshold level is exceeded by frame 1 estimation. As can be seen in FIG. 7, when the frame 1 correlation corresponds to peak correlation, then enhanced two times oversampling results in worst case correlation for frame 2, because the sample bins are shifted to the worst case position. But the resulting average correlation for the two frames will be the same as for the situation illustrated in FIG. 6. Therefore, given an appropriate correlation threshold, the enhanced two times oversampling will still result in synchronization.

The systems and methods for improved synchronization using enhanced two-times oversampling yields several advantages. First, the systems and methods for improved synchronization makes for greater DSP engine efficiency by minimizing the MIPS requirement of the processor. Second, battery life of the mobile station is conserved because the power consumption of a device which incorporates the systems and methods for improved time slot synchronization utilizes a two-times oversampling rate in lieu of a power-inefficient, higher sampling rate, such as 8-times oversampling. Finally, the systems and methods for improved time slot synchronization using enhanced two-times oversampling vastly improves a receiver's ability to acquire and camp a channel despite the presence of signal obstructions that might otherwise render the signal undetectable. This advantage accrues as a direct result of the more frequent above-threshold level correlation made possible by the sample bin-shifting enhancement.

While embodiments and implementations of the invention have been shown and described, it should be apparent that many more embodiments and implementations are within the scope of the invention. Accordingly, the invention is not to be restricted, except in light of the claims and their equivalents.

What is claimed:

1. A time slot synchronizer, comprising:
a sampler configured to:
successively sample a baseband signal comprising a plurality of frames, each frame comprising a plurality of symbols;
divide each symbol into a plurality of sample bins;
generate a first sample group from a first frame by sampling each symbol in the first frame in a first and second sample bin; and
generate a second sample group from a second frame by sampling each symbol in the second frame in a third and fourth sample bin, the third and fourth sample bins being shifted a certain number of sample bins relative to the first and second sample bins, respectively,
a correlator configured to correlate the first and second groups of samples with a stored sync word in order to generate a final correlation estimate, and
a comparator configured to compare the final correlation estimate to a correlation threshold.

2. The synchronizer of claim 1, wherein the total number of sample bins is eight.

3. The synchronizer of claim 1, wherein the third and fourth sample bins are shifted two sample bins relative to the first and second sample bins, respectively.

4. The synchronizer of claim 1, wherein each frame comprises 486 symbols.

5. The synchronizer of claim 1, wherein each frame is divided into a plurality of time slots, there being a sync word at the beginning of each time slot, and wherein correlation with the stored sync word only occurs for the samples generated from the sync words at the beginning of each time slot.

6. The synchronizer of claim 5, wherein each sync word comprises 14 symbols.

7. The synchronizer of claim 5, wherein each frame comprises six time slots.

8. The synchronizer of claim 1, wherein the sampler is configured to generate a first sample group series from a first plurality of frames that includes the first frame by sampling each frame in the first plurality of frames using the first and second sample bins, and wherein the correlator is configured to generate a first correlation estimate comprising the average correlation estimate for each frame in the first plurality of frames, and wherein the comparator is configured to use the first correlation estimate to generate the final correlation estimate.

9. The synchronizer of claim 1, wherein the sampler is configured to generate a second sample group series from a second plurality of frames that includes the second frame by sampling each frame in the second plurality of frames using the third and fourth sample bins, and wherein the correlator is configured to generate a second correlation estimate comprising the average correlation estimate for each frame in the second plurality of frames, and wherein the comparator is configured to use the second correlation estimate to generate the final correlation estimate.

10. A mobile station, comprising:
a receiver for receiving a signal;
a demodulator coupled to the receiver, the demodulator configured to take the signal and to generate a baseband signal comprising a plurality of frames, each frame comprising a plurality of symbols; and
a sampler configured to successively sample the baseband signal by:
dividing each symbol into a plurality of sample bins;
generating a first sample group from a first frame by sampling each symbol in the first frame in a first and second sample bin; and
generating a second sample group from a second frame by sampling each symbol in the second frame in a third and fourth sample bin, the third and fourth sample bins being shifted a certain number of sample bins relative to the first and second sample bins, respectively,
a correlator configured to correlate the first and second groups of samples with a stored sync word in order to generate a final correlation estimate, and
a comparator for comparing the final correlation estimate to a correlation threshold.

11. The mobile station of claim 10, wherein each frame is divided into a plurality of time slots, there being a sync word at the beginning of each time slot, and wherein correlation with the stored sync word only occurs for the samples generated from the sync words at the beginning of each time slot.

12. The mobile station of claim 10, wherein the sampler is configured to generate a first sample group series from a first plurality of frames that includes the first frame by sampling each frame in the first plurality of frames using the first and second sample bins, and wherein the correlator is configured to generate a first correlation estimate comprising the average correlation estimate for each frame in the first plurality of frames, and wherein the comparator is configured to use the first correlation estimate to generate the final correlation estimate.

13. The synchronizer of claim 10, wherein the sampler is configured to generate a second sample group series from a second plurality of frames that includes the second frame by sampling each frame in the second plurality of frames using the third and fourth sample bins, and wherein the correlator is configured to generate a second correlation estimate comprising the average correlation estimate for each frame in the second plurality of frames, and wherein the comparator is configured to use the second correlation estimate to generate the final correlation estimate.

14. The receiver of claim 10, configured to look for a different signal when the correlation estimate does not exceed the correlation threshold.

15. A method for time slot synchronization using a sampler configured to successively sample a baseband signal comprising a plurality of frames, each frame comprising a plurality of symbols, the method comprising:
dividing each symbol into a plurality of sample bins;
generating a first sample group from a first frame by sampling each symbol in the first frame in a first and second sample bin;
generating a second sample group from a second frame by sampling each symbol in the second frame in a third and fourth sample bin, the third and fourth sample bins being shifted a certain number of sample bins relative to the first and second sample bins, respectively;
correlating the first and second groups of samples with a stored sync word in order to generate a final correlation estimate; and
comparing the correlation estimate to a final correlation threshold.

16. The method of claim 15, wherein each frame is divided into a plurality of time slots, there being a sync word at the beginning of each time slot, and wherein correlation with the stored sync word only occurs for the samples generated from the sync words at the beginning of each time slot.

17. The method of claim 15, comprising:
generating a first sample group series from a first plurality of frames that includes the first frame by sampling each frame in the first plurality of frames using the first and second sample bins;
generating a first correlation estimate comprising the average correlation estimate for each frame in the first plurality of frames; and
using the first correlation estimate to generate the final correlation estimate.

18. The method of claim 13, comprising:
generating a second sample group series from a second plurality of frames that includes the second frame by sampling each frame in the second plurality of frames using the third and fourth sample bins;
generating a second correlation estimate comprising the average correlation estimate for each frame in the second plurality of frames; and
using the second correlation estimate to generate the final correlation estimate.
